(19) United States
(12) Patent Application Publication
(10) Pub. No.: US 2024/0100478 A1
(43) Pub. Date: Mar. 28, 2024

(54) CATALYTICALLY ACTIVE PARTICLE FILTER WITH A HIGH DEGREE OF FILTERING EFFICIENCY

(71) Applicant: UMICORE AG & CO. KG, Hanau-Wolfgang (DE)

(72) Inventors: Jan SCHOENHABER, Darmstadt (DE); Gabriela KUCEROVA, Senden (DE); Naina DEIBEL, Pfungstadt (DE); Carolin BRAUN, Angen (DE); Massimo COLOMBO, Frankfurt am Main (DE); Meike Antonia GOTTHARDT, Frankfurt (DE)

(73) Assignee: UMICORE AG & CO. KG, Hanau-Wolfgang (DE)

(21) Appl. No.: 18/256,407

(22) PCT Filed: Dec. 14, 2021
(86) PCT No.: PCT/EP2021/085652

§ 371 Date: Jun. 7, 2023

(30) Foreign Application Priority Data
Dec. 15, 2020 (EP) 20214159.4

(51) Int. Cl. B01D 53/94; B01J 23/10; B01J 23/46; B01J 35/00; B01J 35/40; B01J 35/57; F01N 3/022; F01N 3/035

(52) U.S. Cl. CPC B01D 53/945; B01D 53/9472; B01J 23/10; B01J 23/464; B01J 35/19; B01J 35/40; B01J 35/57; F01N 3/0222; F01N 3/035; B01D 2255/1023; B01D 2255/1025; B01D 2255/407; B01D 2255/9155; B01D 2255/9202; B01D 2258/014; F01N 2510/063; F01N 2510/068

(57) ABSTRACT

The present invention relates to a wall flow filter for removing particles from the exhaust gas of internal combustion engines, which comprises a wall flow filter substrate having a length L and coatings Z and F that differ from one another, wherein the wall flow filter substrate comprises channels E and A, which extend in parallel between a first and a second end of the wall flow filter substrate, are separated by porous walls and form surfaces OE or OA, and wherein the channels E are closed at the second end and the channels A are closed at the first end, and wherein the coating Z is located in the porous walls and/or on the surfaces OA, but not on the surfaces OE, and comprises palladium and/or rhodium a cerium/zirconium mixed oxide, characterized in that the coating F is located in the porous walls and/or on the surfaces OE, but not on the surfaces O, and comprises a ceramic membrane and no precious metal.

The present invention relates to a wall flow filter, to a method for the production thereof and the use thereof for reducing harmful exhaust gases of an internal combustion engine.

Diesel particulate filters or gasoline particulate filters with and without an additional catalytically active coating are suitable aggregates for removing particle emissions and reducing harmful substances in exhaust gases. These are wall flow honeycomb bodies, which are referred to as catalyst supports, carriers or substrate monoliths. In order to meet the legal standards, it is desirable for current and future applications for the exhaust gas aftertreatment of internal combustion engines to combine particulate filters with other catalytically active functionalities not only for reasons of cost but also for installation space reasons. The catalytically active coating can be located on the surface or in the walls of the channels forming this surface. The catalytically active coating is often applied to the catalyst support in the form of a suspension in a so-called coating operation. Many such processes have been published in the past by automotive exhaust-gas catalyst manufacturers; see, for example, EP1064094B1, EP2521618B1, WO10015573A2, EP1136462B1, U.S. Pat. No. 6,478,874B1, U.S. Pat. No. 4,609,563A, WO9947260A1, JP5378659B2, EP2415522A1, and JP2014205108A2.

The use of a particulate filter, whether catalytically coated or not, leads to a noticeable increase in the exhaust-gas back pressure in comparison with a flow-through support of the same dimensions and thus to a reduction in the torque of the engine or possibly to increased fuel consumption. In order to not increase the exhaust-gas back pressure even further, the amounts of oxidic support materials for the catalytically active noble metals of the catalyst or oxidic catalyst materials are generally applied in smaller quantities in the case of a filter than in the case of a flow-through support. As a result, the catalytic effectiveness of a catalytically coated particle filter is frequently inferior to that of a flow-through monolith of the same dimensions.

There have already been some efforts to provide particulate filters that have good catalytic activity due to an active coating and yet have the lowest possible exhaust-gas back pressure. With regard to a low exhaust-gas back pressure, it has proven to be expedient if the catalytically active coating is not present as a layer on the channel walls of a porous wall flow filter, but the channel walls of the filter are instead interspersed with the catalytically active material; see, for instance, WO2005016497A1, JPH01-151706, and EP1789190B1. For this purpose, the particle size of the catalytic coating is selected such that the particles penetrate into the pores of the wall flow filters and can be fixed there by calcination. A disadvantage of catalytically active filters having an in-wall coating is that the amount of catalytically active substance is limited by the absorption capacity of the porous wall.

It has been found that, by applying the catalytically active substances to the surfaces of the channel walls of a wall flow honeycomb body, an increase in the conversion of the harmful substances in the exhaust gas can be achieved. Combinations of on-wall coating and in-wall coating with catalytically active material are also possible, as a result of which the catalytic performance can be further increased without substantially increasing the back pressure.

In addition to the catalytic effectiveness, a further functionality of the filter that can be improved by a coating is its filtration efficiency, i.e., the filtering effect itself. WO 2011151711A1 describes a method by means of which a dry aerosol is applied to a non-coated or catalytically coated filter that carries the catalytic active material in the channel walls (in-wall coating with a washcoat). The aerosol is provided by the distribution of a powdered mineral material and is guided through the inlet side of a wall flow filter by means of a gas stream. In this case, the individual particles having a particle size of 0.2 μm to 5 μm agglomerate to form a bridged network of particles and are deposited as a layer on the surface of the individual inlet channels passing through the wall flow filter. The typical powder loading of a filter is between 5 g and 50 g per liter of filter volume. It is expressly pointed out that it is not desirable to obtain a coating inside the pores of the wall flow filter with the metal oxide.

A further method for increasing the filtration efficiency of catalytically inactive filters is described in WO2012030534A1. In this case, a filtration layer (“discriminating layer”) is created on the walls of the flow channels of the inlet side by the deposition of ceramic particles via a particle aerosol. The layers consist of oxides of zirconium, aluminum, or silicon, preferably in fiber form ranging from 1 nm to 5 μm in length, and have a layer thickness greater than 10 μm, typically 25 μm to 75 μm. After the coating process, the applied powder particles are calcined in a thermal process.

A further method in which a membrane (“trapping layer”) is produced on the surfaces of the inlet channels of filters in order to increase the filtration efficiency of catalytically inactive wall flow filters is described in patent specification U.S. Pat. No. 8,277,880B2. The filtration membrane on the surfaces of the inlet channels is produced by sucking through a gas stream loaded with ceramic particles (for example, silicon carbide or cordierite). After application of the filter layer, the honeycomb body is fired at temperatures greater than 1000° C. in order to increase the adhesive strength of the powder layer on the channel walls. EP2502661A2 and EP2502662B1 mention further on-wall coatings by powder application.

Coating inside the pores of a wall flow filter substrate by spraying dry particles is described in US838872162. In this case, however, the powder should penetrate deeply into the pores. 20% to 60% of the surface of the wall should remain accessible to soot particles, thus open. Depending on the flow velocity of the powder/gas mixture, a more or less steep powder gradient between the inlet and outlet sides can be adjusted. The pores of the channel walls of the filter coated with powder in the pores according to U.S. Pat. No. 8,388,721B2 can subsequently be coated with a catalytically active component. Here as well, the catalytically active material is located in the channel walls of the filter. The introduction of the powder into the pores, for example by means of an aerosol generator, is also described in EP2727640A1. Here, a non-catalytically coated wall flow filter is coated using a gas stream containing, for example, aluminum oxide particles in such a way that the complete particles, which have a particle size of 0.1 μm to 5 μm, are deposited as a porous filling in the pores of the wall flow filter. The particles themselves can realize a further functionality of the filter in addition to the filtering effect. For example, these particles are deposited in the pores of the filter in an amount greater than 80 g/l based on the filter volume. They fill in 10% to 50% of the volume of the filled pores in the channel walls. This filter, both loaded with soot and without soot, has an improved filtration efficiency compared to the untreated filter together with a low exhaust-gas back pressure of the soot-loaded filter.

In WO2018115900A1, wall flow filters are coated with an optionally dry synthetic ash in such a way that a continuous membrane layer is formed on the walls of the optionally catalytically coated wall flow filter.

All of the prior art patents listed above have the aim of increasing the filtration efficiency of a filter by coating the filter with a powder. The filters optimized in this way can also carry a catalytically active coating in the porous channel walls before the powder coating. However, there are no indications in any of the examples to simultaneously optimize the catalytic effect of a filter and increase filtration efficiency.

Therefore, there continues to be a need for particulate filters with which both catalytic activity and filtration efficiency are optimized with respect to exhaust-gas back pressure. The object of the present invention is to provide a corresponding particulate filter with which a sufficient filtration efficiency is coupled with the lowest possible increase in the exhaust-gas back pressure and a high catalytic activity.

These and other objects which are obvious from the prior art are achieved by a particulate filter according to claims 1 to 16. Claim 17 is directed to the production of a particulate filter according to the invention. Claim 18 aims at using the particulate filter for the exhaust-gas aftertreatment of internal combustion engines.

The present invention relates to a wall flow filter for removing particles from the exhaust gas of combustion engines, which comprises a wall flow filter having a length L and coatings Z and F that differ from one another, wherein the wall flow filter substrate comprise channels E and A, which extend in parallel between a first and a second end of the wall flow filter substrate, are separated by porous walls, and form the surfaces O_{E} or O_{A}, and wherein the channels E are closed at the second end and the channels A are closed at the first end, and
wherein the coating Z is located in the porous walls and/or on the surfaces O_{A}, but not on the surfaces O_{E}, and comprises palladium and/or rhodium and a cerium/zirconium mixed oxide, characterized in that the coating F is located in the porous walls and/or on the surfaces O_{E}, but not on the surfaces O_{A}, and comprises a ceramic membrane and no precious metal.

In the intended use of the wall flow filter according to the invention for cleaning exhaust gas of internal combustion engines, the exhaust gas flows into the filter at one end and leaves it again after passing through the porous walls at the other end. Therefore, if the exhaust gas enters the filter at the first end, for example, the channels E denote the inlet channels or inflow-side channels. After passing through the porous walls, it then exits the filter at the second end, such that the channels A denote the outlet channels or outflow-side channels.

All ceramic wall flow filter substrates known from the prior art and customary in the field of automobile exhaust gas catalysis can be used as wall flow substrates. Porous wall flow filter substrates made of cordierite, silicon carbide, or aluminum titanate are preferably used. These wall flow filter substrates have channels E and channels A which, as described above, act as inlet channels, which can also be called inflow channels, and as outlet channels, which can also be called outflow channels. The outflow-side ends of the inflow channels and the inflow-side ends of the outflow channels are closed off from one another in an offset manner with generally gas-tight “plugs”. In this case, the exhaust gas that is to be purified and that flows through the filter substrate is forced to pass through the porous wall between the inflow channel and outflow channel, which brings about a particulate filtering effect. The filtration property for particulates can be designed by means of the porosity, pore/radii distribution, and thickness of the wall. According to the invention, the porosity of the uncoated wall flow filter substrates is typically more than 40%, for example from 40% to 75%, particularly from 50% to 70% [measured according to DIN 66133, latest version on the filing date]. The average pore size d₅₀ of the uncoated wall flow filter substrates is at least 7 μm, for example from 7 μm to 34 μm, preferably more than 10 μm, in particular more preferably from 10 μm to 25 μm or most preferably from 15 μm to 20 μm [measured according to DIN 66134, latest version on the filing date] ], wherein the d₅₀ value of the pore size distribution of the wall flow filter substrate is understood to mean that 50% of the total pore volume determinable by mercury porosimetry is formed by pores whose diameter is less than or equal to the value specified as d₅₀. In the case of the wall flow filters according to the invention, the wall flow filter substrates provided with the coatings Z and F and optionally coating Y (see below) particularly preferably have a pore size d₅₀ from 10 μm to 20 μm and a porosity from 40% to 65%.

It is known to the person skilled in the art that, due to the plugs closing off the channels E and A from one another in an offset manner, the entire length L of the wall flow filter substrate may not be available for coating. For example, the channels E are closed at the second end of the wall flow filter substrate, such that the surface O_{E} available for coating can consequently be slightly smaller than the length L. This, of course, only applies if a coating is present on 100% of the length L or slightly below. In these cases, for the sake of simplicity, 100% of the length L is still referred to below.

If the coating Z is located on the surfaces O_{A} of the wall flow filter substrate, it preferably extends from the second end of the wall flow filter substrate to 50 to 90% of the length L.

The coating on the surfaces O_{A} is a so-called on-wall coating. This means that the coating rises above the surfaces O_{A} into the channels A of the wall flow filter substrate, thus reducing the channel cross section. In this embodiment, the pores of the porous wall which are adjacent to the surfaces O_{A} are filled with the coating Z only to a minor extent. More than 80%, preferably more than 90%, of the coating Z is not located in the porous wall.

On-wall coatings have a certain elevation above the wall surface. However, the thickness of the layers Z and Y is generally 5-250 μm, preferably 7.5-225 μm and most preferably 10-200 μm, wherein the thickness of the layer is preferably determined in the middle of a respective channel web and not in the corners. Standard analytical methods known to the person skilled in the art, such as scanning electron microscopy, are suitable for determining the layer thickness.

If the coating Z is located in the porous walls of the wall flow filter substrate, it preferably extends from the first end of the wall flow filter substrate to 50 to 100% of the length L.

The coating in the porous walls is a so-called in-wall coating. In this embodiment, the surfaces O_{A} adjacent to the porous walls are coated with the coating Z only to a minor extent.

The minimum length of the coating Z is at least 1.25 cm, preferably at least 2.0 cm and most preferably at least 2.5 cm, calculated from the second end of the wall flow filter substrate.

The coating Z can have a thickness gradient over the length L such that the thickness of the coating Z increases along the length L of the wall flow filter from the second end towards the first end. In this case, the coating may preferably have more than 2 times, more preferably up to more than 3 times the thickness at one coating end than at the other coating end. In this case, the thickness is the height at which the coating Z rises above the surface O_{A}. The thickness gradient of the coating on the channel walls also makes it possible for the filtration efficiency to be adjusted over the entire length L of the filter. The result is a more uniform deposition of the soot over the entire filter wall and thus an improved exhaust-gas back pressure increase and possibly a better burn-off of the soot.

However, the coating Z can also have a thickness gradient over the length L such that the thickness of the coating Z decreases along the length L of the wall flow filter from the second end towards the first end. In this case, the coating may preferably have more than 2 times, more preferably up to more than 3 times the thickness at one coating end than the other coating end. In this case, the thickness is the height at which the coating Z rises above the surface O_{A}. The thickness gradient of the coating on the channel walls also makes it possible for the filtration efficiency to be adjusted over the entire length L of the filter. The result is a more uniform deposition of the soot over the entire filter wall and thus an improved exhaust-gas back pressure increase and possibly a better burn-off of the soot.

The coating Z is a catalytically active coating in particular due to the constituents palladium and/or rhodium. In the context of the present invention, “catalytically active” is understood to mean the ability to convert harmful constituents of the exhaust gas from internal combustion engines into less harmful ones. The exhaust gas constituents NON, CO, and HC should be mentioned here in particular. Consequently, coating Z is particularly preferably three-way catalytically active, in particular at operating temperatures of 250 to 1100° C.

Coating Z contains the noble metals palladium and/or rhodium, with platinum also being present as a further noble metal only in exceptional cases. Particularly preferably, coating Z contains palladium and rhodium and no platinum.

In a further embodiment, coating Z contains the precious metals platinum and/or rhodium, with palladium also being present as a further precious metal only in exceptional cases.

In a further embodiment, coating Z contains the noble metals platinum and palladium and optionally rhodium. In this embodiment, it is advantageous if the mass ratio of platinum to palladium is 15:1 to 1:15, in particular 10:1 to 1:10.

Based on the particulate filter according to the invention, the proportion of rhodium in the entire precious metal content is in particular greater than or equal to 5% by weight, preferably greater than or equal to 10% by weight. For example, the proportion of rhodium in the total noble metal content is 5 to 20% by weight or 5 to 15% by weight. The noble metals are usually used in quantities of 0.10 to 5 g/l based on the volume of the wall flow filter substrate.

The noble metals are usually fixed on one or more carrier materials. All materials that are familiar to the person skilled in the art for this purpose are considered as support materials. Such materials are in particular metal oxides with a BET surface area of 30 to 250 m²/g, preferably 100 to 200 m²/g (determined according to DIN 66132, latest version as of filing date). Particularly suitable carrier materials for the precious metals are selected from the series consisting of aluminum oxide, doped aluminum oxide, silicon oxide, titanium dioxide and mixed oxides of one or more thereof. Doped aluminum oxides are, for example, aluminum oxides doped with lanthanum oxide, zirconium oxide, barium oxide and/or titanium oxide. Aluminum oxide or lanthanum-stabilized aluminum oxide is advantageously used, wherein lanthanum is used in quantities of 1 to 10% by weight, preferably 3 to 6% by weight, in each case calculated as La₂O₃ and based on the weight of the stabilized aluminum oxide.

Also in the case of aluminum oxide doped with barium oxide, the proportion of barium oxide is in particular 1 to 10% by weight, preferably 3 to 6% by weight, in each case calculated as BaO and based on the weight of the stabilized aluminum oxide.

Another suitable carrier material is lanthanum-stabilized aluminum oxide the surface of which is coated with lanthanum oxide, with barium oxide and/or with strontium oxide.

Coating Z preferably comprises at least one aluminum oxide or doped aluminum oxide.

Coating Z contains at least one cerium/zirconium mixed oxide that acts as an oxygen storage component. The mass ratio of cerium oxide to zirconium oxide in these products can vary within wide limits. It is, for example, 0.1 to 1.5, preferably 0.15 to 1 or 0.2 to 0.9.

Preferred cerium/zirconium mixed oxides comprise one or more rare earth metal oxides and can thus be referred to as cerium/zirconium/rare earth metal mixed oxides. The term “cerium-zirconium-rare-earth metal mixed oxide” within the meaning of the present invention excludes physical mixtures of cerium oxide, zirconium oxide, and rare earth oxide. Rather, “cerium/zirconium/rare earth metal mixed oxides” are characterized by a largely homogeneous, three-dimensional crystal structure that is ideally free of phases of pure cerium oxide, zirconium oxide or rare earth oxide (solid solution). Depending on the manufacturing process, however, not completely homogeneous products may arise which can generally be used without any disadvantage. The same applies to cerium/zirconium mixed oxides which do not contain any rare earth metal oxide. In all other respects, the term “rare earth metal” or “rare earth metal oxide” within the meaning of the present invention does not include cerium or cerium oxide.

Lanthanum oxide, yttrium oxide, praseodymium oxide, neodymium oxide and/or samarium oxide can, for example, be considered as rare earth metal oxides in the cerium-zirconium-rare earth metal mixed oxides. Lanthanum oxide, yttrium oxide and/or praseodymium oxide are preferred. Lanthanum oxide and/or yttrium oxide are particularly preferred, and lanthanum oxide and yttrium oxide, yttrium oxide and praseodymium oxide, and lanthanum oxide and praseodymium oxide are more particularly preferred. In embodiments of the present invention, the oxygen storage components are free of neodymium oxide.

The proportion of rare earth metal oxide in the cerium/zirconium/rare earth metal mixed oxides is in particular 3 to 20% by weight based on the cerium/zirconium/rare earth metal mixed oxide.

If the cerium/zirconium/rare earth metal mixed oxides contain yttrium oxide as a rare earth metal, the proportion thereof is preferably 4 to 15% by weight based on the cerium/zirconium/rare earth metal mixed oxide. If the cerium/zirconium/rare earth metal mixed oxides contain praseodymium oxide as a rare earth metal, the proportion thereof is preferably 2 to 10% by weight based on the cerium/zirconium/rare earth metal mixed oxide. If the cerium/zirconium/rare earth metal mixed oxides contain lanthanum oxide and a further rare earth oxide as a rare earth metal, such as yttrium oxide or praseodymium oxide, the mass ratio thereof is in particular 0.1 to 1.25, preferably 0.1 to 1.

The coating Z usually contains oxygen storage components in quantities of 15 to 120 g/l, based on the volume of the wall flow-flow filter substrate. The mass ratio of carrier materials and oxygen storage components in the coating Z is usually 0.25 to 1.5, for example 0.3 to 1.3.

For example, the weight ratio of the sum of the masses of all aluminum oxides (including doped aluminum oxides) to the sum of the masses of all cerium/zirconium mixed oxides in coating Z is 10:90 to 75:25.

In embodiments of the present invention, the coating Z comprises lanthanum-stabilized aluminum oxide, rhodium, palladium or palladium and rhodium, and a cerium/zirconium/rare earth metal mixed oxide containing yttrium oxide and lanthanum oxide as rare earth metal oxides.

In other embodiments of the present invention, the coating Z comprises lanthanum-stabilized aluminum oxide, rhodium, palladium or palladium and rhodium, and a cerium/zirconium/rare earth metal mixed oxide containing praseodymium oxide and lanthanum oxide as rare earth metal oxides.

In other embodiments of the present invention, the coating Z comprises lanthanum-stabilized aluminum oxide, rhodium, palladium, or palladium and rhodium, a cerium/zirconium/rare earth metal mixed oxide containing praseodymium oxide and lanthanum oxide as rare earth metal oxides, and a second cerium/zirconium/rare earth metal mixed oxide containing yttrium oxide and lanthanum oxide as rare earth metal oxides.

The coating Z preferably does not contain a zeolite or a molecular sieve.

If the coating Z contains aluminum oxide or doped aluminum oxide, the weight ratio of the sum of the masses of all aluminum oxides or doped aluminum oxides to the sum of the masses of all cerium/zirconium mixed oxides or cerium/zirconium/rare earth metal mixed oxides is in particular 10:90 to 75:25.

According to the invention, coating F comprises a membrane. In the context of the present invention, this is understood to mean a defined layer which reduces and standardizes the effective pore size of the ceramic filter substrate and thereby improves the filtration performance. In particular, the membrane is a coherent layer with a layer thickness of 1 to 150 μm. Coating F does not comprise a precious metal and is therefore not catalytically active in the sense of the present invention. It is therefore not able to oxidize the CO and HC exhaust gas components or to reduce NON.

Coating F preferably consists of a coherent membrane on the surfaces O_{E} and extends in particular over the entire length L of the filter substrate.

Suitable ceramic membranes contain in particular one or more elements selected from the group consisting of silicon, aluminum, titanium, zirconium, cerium, iron, zinc, magnesium, tin and carbon.

In particular, the ceramic membrane contains aluminum oxide, zirconium dioxide, cerium oxide, zirconium oxide, yttrium oxide, mullite, tin oxide, silver nitride, zeolite, titanium dioxide, silicon dioxide, aluminum titanate, silicon carbide, cordierite, or mixtures of two or more of these materials.

In one embodiment according to the invention, the coating F preferably forms a coherent membrane layer on the surfaces O_{E} and extends over the entire length L of the filter substrate. The membrane layer is defined in particular as a coherent porous layer with a porosity in the range of 30-80%, preferably 70-40%. The average pore size d₅₀ of the membrane layer is at least 50 μm, for example from 50 μm to 5 μm, preferably more than 100 μm to 4 μm, in particular more preferably from 200 μm to 2.5 μm, wherein the d₅₀ value of the pore size distribution of the wall flow filter substrate is understood to mean that 50% of the total pore volume determinable by mercury porosimetry is formed by pores whose diameter is less than or equal to the value specified as d₅₀.

Advantageously, the average pore size d₅₀ of the membrane coating F is smaller than the average pore size d₅₀ of the wall flow filter substrate. The ratio of the d₅₀ of the membrane coating F to the d₅₀ of the wall flow filter substrate is 0.005 to 0.5, preferably 0.01 to 0.4 and particularly preferably 0.02 to 0.2.

Particularly suitable ceramic membranes contain aluminum oxide, zirconium dioxide, cerium oxide, yttrium oxide, mullite, tin oxide, silicon nitride, zeolite, titanium dioxide, silicon dioxide, aluminum titanate, silicon carbide, cordierite, or mixtures thereof.

For example, the ceramic membrane is a silicon carbide membrane.

The coating F advantageously has a mass of less than 150 g/L, preferably 5 to 130 g/L, particularly preferably 20 to 100 g/L, in each case based on the volume of the wall flow filter substrate.

It is moreover advantageous if the mass ratio of coating Z to coating F is 0.1 to 25, preferably 0.1 to 20, particularly preferably 0.15 to 15. It is also advantageous if the ratio of the wall thickness of the wall flow filter substrate to the thickness of the coating F is 0.8 to 400, in particular 5 to 250.

The wall flow filter according to the invention can have an increasing concentration gradient of the coating F in the longitudinal direction of the filter from its first to the second end. According to the invention, the term “increasing gradient” refers to the fact that the gradient of the concentration of the coating F in the filter increases in the axial direction from one end to the other, possibly from negative values to more positive values.

In the case of an intended use of the wall flow filter in which the exhaust gas flows in at its first end and out at the second end, a larger amount of coating F is preferably located near the second end of the wall flow filter substrate and a significantly smaller amount of coating F is located near the first end of the wall flow filter substrate.

Simulations of the gas flow in a wall flow filter have shown that the last third of the substrate is mainly (more than 50%) responsible for the filtration property of the overall filter. An increased application of a coating F on the last third of the filter additionally increases the back pressure there, this being due to the lower permeability, and the throughflow shifts more into the first two thirds of the filter. The filter should therefore have a more rapidly increasing gradient of the coating F from the first to the second end in order to increase its filtration effect. This applies mutatis mutandis to the adjustment of an advantageous exhaust-gas back pressure. Accordingly, a gradient of the concentration of coating F that increases less strongly should optionally be selected here.

The coating F is preferably located on the porous walls of the wall flow filter substrate but can also be entirely or partially located in the porous walls of the wall flow filter substrate. It follows from this that the particle size of the ceramic membrane must be adapted to the pore size of the wall flow filter substrate. The particles of the ceramic membrane thus have in particular a defined particle size distribution. According to the invention, the ceramic membrane F preferably has a monomodal or a multimodal or broad q3 particle size distribution.

Depending on the method by which the quantity of particles is determined, to define the particle size or grain size distribution of the ceramic membrane, a distinction is made inter alia between number-related (q0) and volume-related (q3) grain size distributions (M. Stieα, Mechanische Verfahrenstechnik—Partikeltechnologie 1 (Mechanical Process Technology—Particle Technology 1), Springer, 3rd edition 2009, page 29).

If coating F is located on the porous walls of the wall flow filter substrate, the d₅₀ value of the particle size distribution of the membrane particles is in particular greater than or equal to the d₅ value of the pore size distribution of the wall flow filter substrate.

Depending on the pore size distribution of the wall flow substrate, the d₉₀ value of the particle size distribution of the membrane particles can be greater than or equal to the d₉₅ value of the pore size distribution of the wall flow substrate or less than the d₉₅ value of the pore size distribution of the wall flow substrate.

If coating F is located entirely or partially in the porous walls of the wall flow filter substrate, for example, 1 to 50% of the total mass of the coating F, preferably 1.5 to 40% and very particularly preferably 2 to 25% is located in the porous walls of the wall flow filter substrate.

If coating F is located entirely or partially in the porous walls of the wall flow filter substrate, the d₅₀ value of the particle size distribution of the membrane particles is in particular less than the d₅ value of the pore size distribution of the wall flow filter substrate.

Furthermore, the d₉₀ value of the particle size distribution of the membrane particles is in particular less than the d₉₅ value of the pore size distribution of the wall flow substrate.

In particular, the membrane particles have a d₅₀ value of 0.01 μm to 15 μm, in particular of 0.05 μm to 9 μm.

The membrane particles have in particular a d₉₀ value of 0.1 to 70 μm, preferably 1 to 50 μm and particularly preferably 2 to 45 μm

The coating F has in particular a layer thickness of 1 to 150 μm, preferably 2 to 50 μm.

If the coating F penetrates the porous filter wall, the penetration depth is limited. In particular, the penetration depth of the coating F into the filter wall is at most 50% of the wall thickness, preferably at most 40% and very particularly preferably at most 25%.

The coating F has in particular a porosity of 25 to 65%, preferably 40 to 65%.

The coating F generally forms a coherent, continuous layer on the surface O_{E}.

The coating F may extend over the entire length L of the wall flow filter substrate or only over a portion thereof. For example, coating F extends over to 100, 25 to 80 or 40 to 60% of the internal length L of the channels E.

In one embodiment of the wall flow filter according to the invention, the coating F extends over the entire length L of the channels E and abuts the closure plugs at the end of the channel. The thickness of the coating F in front of the plug is preferably 0.1 to 10 mm, in particular 0.25 to 5 mm.

In one embodiment of the wall flow filter according to the invention, the wall flow filter substrate has a coating Y which is different from the coatings Z and F, which comprises platinum, palladium or platinum and palladium, which contains no rhodium and no cerium/zirconium mixed oxide and which is located in the porous walls and/or on the surfaces O_{E}, but not on the surfaces O_{A}. Preferably, coating Y contains platinum and palladium with a mass ratio of platinum to palladium of 25:1 to 1:25, particularly preferably 15:1 to 1:2.

In the coating Y, platinum, palladium or platinum and palladium are usually fixed on one or more carrier materials.

All materials that are familiar to the person skilled in the art for this purpose are considered as support materials. Such materials are in particular metal oxides with a BET surface area of 30 to 250 m²/g, preferably 100 to 200 m²/g (determined according to DIN 66132, latest version as of filing date). Particularly suitable carrier materials are selected from the series consisting of aluminum oxide, doped aluminum oxide, silicon oxide, titanium dioxide and mixed oxides of one or more thereof. Doped aluminum oxides are, for example, aluminum oxides doped with lanthanum oxide, zirconium oxide, barium oxide and/or titanium oxide. Aluminum oxide or lanthanum-stabilized aluminum oxide is advantageously used, wherein in the latter case lanthanum is used in quantities of 1 to 10% by weight, preferably 3 to 6% by weight, in each case calculated as La₂O₃ and based on the weight of the stabilized aluminum oxide.

Also in the case of aluminum oxide doped with barium oxide, the proportion of barium oxide is in particular 1 to 10% by weight, preferably 3 to 6% by weight, in each case calculated as BaO and based on the weight of the stabilized aluminum oxide.

Another suitable carrier material is lanthanum-stabilized aluminum oxide the surface of which is coated with lanthanum oxide, with barium oxide and/or with strontium oxide.

Coating Y preferably comprises at least one aluminum oxide or doped aluminum oxide.

In one embodiment, the coating Y is located on the surfaces O_{E} of the wall flow filter substrate and extends, starting from its first end, over a length of 50 to 90% of the length L.

In another embodiment, the coating Y is located in the porous walls of the wall flow filter substrate and extends, from its first end, preferably over a length of 50 to 100% of the length L.

If coating Y is present, the mass ratio of coating Y to coating Z is preferably 0.05 to 8.5.

For example, the carrier material of coating Y has a larger pore volume than the carrier material of coating Z. The ratio of the specific surfaces of the carrier oxides of coating Y to coating Z is preferably 0.5 to 2, in particular 0.7 to 1.5.

For example, the ratio of the pore volume of the ceramic membrane of coating F to the pore volume of the carrier material of coating Z is preferably 0.01 to 3, in particular 0.05 to 2.5. The ratio of the specific surfaces of the ceramic membrane of coating F to the specific surface area of the carrier oxides of coating Z is preferably 0.1 to 4, in particular 0.25 to 3.

The coatings Z, F and, if present, Y can be arranged on the wall flow filter substrate in various ways. FIGS. 1 to 10 explain this by way of example, wherein FIGS. 1 to 4 relate to wall flow filters according to the invention which comprise only the coatings Z and F, while the wall flow filters according to the invention as shown in FIGS. 5 to 10 additionally comprise the coating Y.

FIG. 1 relates to a wall flow filter according to the invention in which the coating Z is located in the channels A on the surfaces O_{A} and extends from the second end of the wall flow filter substrate over 50% of the length L. The coating F is located in the channels E and extends over the entire length L.

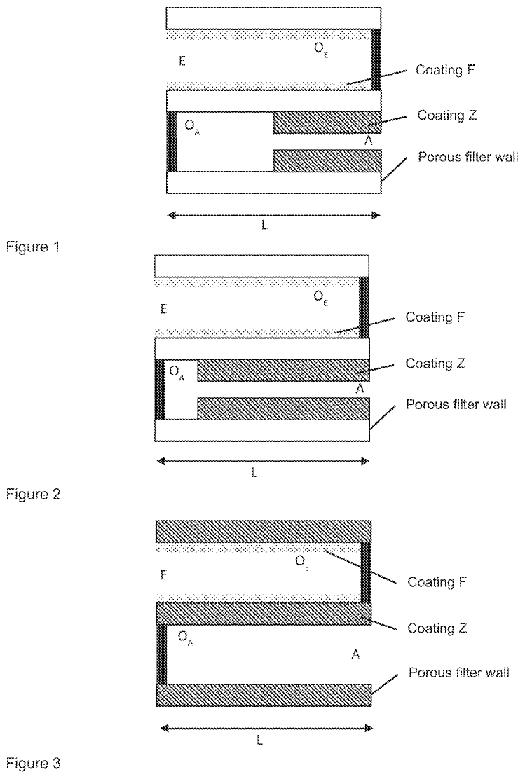

FIG. 2 also relates to a wall flow filter according to the invention in which the coating Z is located in the channels A on the surfaces O_{A}. Starting from the second end of the wall flow filter substrate, however, it extends over 80% of the length L. The coating F is located in the channels E and extends over the entire length L.

FIG. 3 relates to a wall flow filter according to the invention in which the coating Z is located in the porous walls and extends over the entire length L. The coating F is located in the channels E and likewise extends over the entire length L.

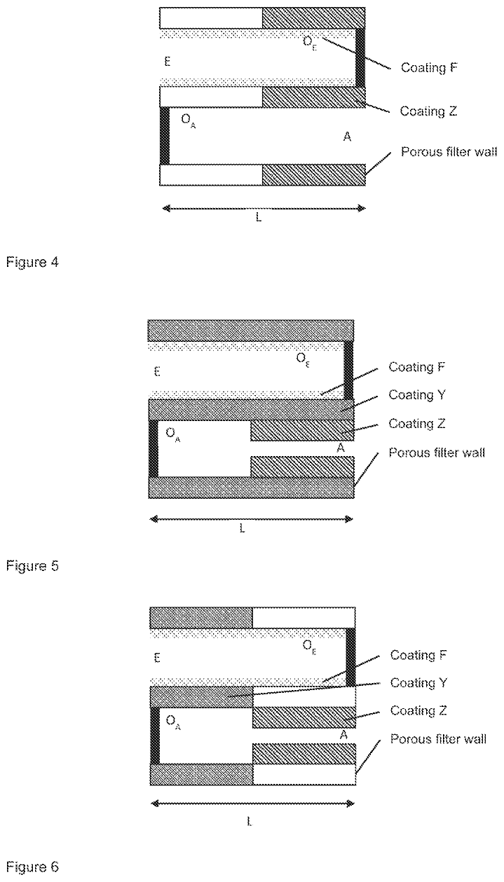

FIG. 4 relates to a wall flow filter according to the invention in which the coating Z is located in the porous walls and extends from the second end of the wall flow filter substrate over 50% of the length L. The coating F is located in the channels E and extends over the entire length L.

FIG. 5 relates to a wall flow filter according to the invention which differs from that of FIG. 4 in that coating Z is located over 50% of the length L on the surfaces O_{A} and additionally coating Y is located in the porous walls over the entire length L. The coating F is located in the channels E and extends over the entire length L.

FIG. 6 relates to a wall flow filter according to the invention which differs from that of FIG. 4 in that coating Z extends over 50% of the length L on the surfaces O_{A} and additionally coating Y extends in the porous walls, starting from the first end of the wall flow filter substrate, over 50% of the length L. The coating F is located in the channels E and extends over the entire length L.

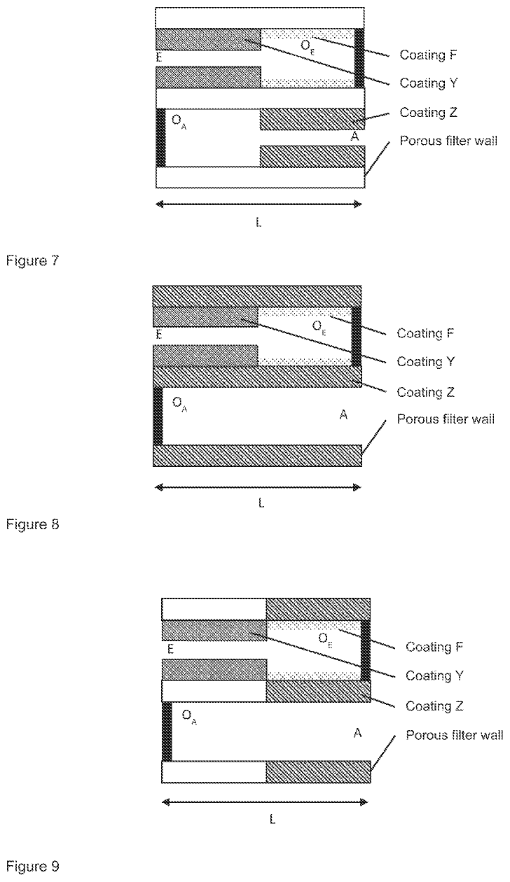

FIG. 7 relates to a wall flow filter according to the invention in which the coating Z is located in the channels A on the surfaces O_{A} and extends over 50% of the length L. In addition, coating Y is located in the channels E on the surfaces O_{E} and extends from the first end of the wall flow filter substrate over 50% of the length L. The coating F is located the channels E and extends from the second end of the wall flow filter substrate over 50% of the length L.

FIG. 8 relates to a wall flow filter according to the invention in which the coating Z is located in the porous walls and extends over the entire length L. In addition, coating Y is located in the channels E on the surfaces O_{E} and extends from the first end of the wall flow filter substrate over 50% of the length L. The coating F is located the channels E and extends from the second end of the wall flow filter substrate over 50% of the length L.

FIG. 9 relates to a wall flow filter according to the invention in which the coating Z is located in the porous walls and extends from the second end of the wall flow filter substrate over 50% of the length L. In addition, coating Y is located in the channels E on the surfaces O_{E} and extends from the first end of the wall flow filter substrate over 50% of the length L. The coating F is located the channels E and extends from the second end of the wall flow filter substrate over 50% of the length L.

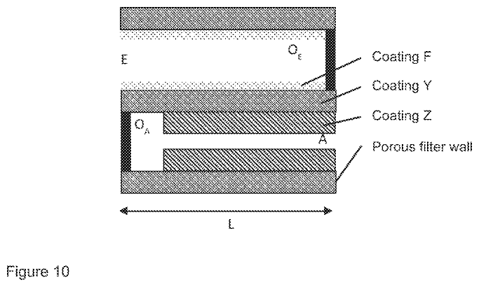

FIG. 10 relates to a wall flow filter according to the invention in which the coating Z is located in the channels A on the surfaces O_{A} and extends from the second end of the wall flow filter substrate over 80% of the length L. In addition, coating Y is located in the porous walls and extends over the entire length L. The coating F is located the channels E and extends over the entire length L.

The wall flow filter according to the invention can be produced by applying the coatings Z, F and, if present, Y to a wall flow filter substrate.

In this case, the catalytic activity is provided as specified by the person skilled in the art by coating the wall flow filter substrate with the coating Z and, if present, with the coating Y.

The term “coating” is accordingly to be understood to mean the application of catalytically active materials to a wall flow filter substrate. The coating assumes the actual catalytic function. In the present case, the coating is carried out by applying a correspondingly low-viscosity aqueous suspension of the catalytically active components, also referred to as a washcoat, into or onto the wall of the wall flow filter substrate, for example in accordance with EP178919061. After application of the suspension, the wall flow filter substrate is dried in each case and, if applicable, calcined at an increased temperature. The catalytically coated filter preferably has a loading of 20 g/l to 200 g/l, preferably 30 g/l to 150 g/l (coating Z or sum of the coatings Z and Y). The most suitable amount of loading of a filter coated in the wall depends on its cell density, its wall thickness, and the porosity.

The coating F can likewise be applied to the surfaces O_{E} by a wet-chemical coating step E. For example, the membrane coating F is first coated onto the surfaces O_{E} and subsequently, after calcination, the coatings Y, if present, and Z.

However, the coatings Y, if present, and Z can also be applied first and then the membrane coating F can be coated onto the surfaces O_{E}.

Methods suitable for producing the coating F are sufficiently known to the person skilled in the art and are described in detail, for example, in WO 2013/070535 A1.

The catalytically coated wall flow filters according to the invention differ from those that are produced in the exhaust system of a vehicle by ash deposition during operation. According to the invention, the catalytically active wall flow filter substrates are selectively provided with a coating F. As a result, the balance between filtration efficiency and exhaust-gas back pressure can be adjusted selectively right from the start. Wall flow filters in which undefined ash deposits have resulted from combustion of fuel, e.g., in the cylinder during driving operation or by means of a burner, are therefore not included in the present invention.

The wall flow filter according to the invention exhibits excellent filtration efficiency with only a moderate increase in the exhaust-gas back pressure as compared to a wall flow filter, without the coating F, in the fresh state. The wall flow filter according to the invention preferably exhibits an improvement in soot particle deposition (filtering effect) in the filter of at least 5%, preferably at least 10% and very particularly preferably at least 20% at a relative increase in the exhaust-gas back pressure of the fresh wall flow filter of at most 40%, preferably at most 20% and very particularly preferably at most 10% as compared with a fresh filter coated with catalytically active material but not provided with coating F. The slight increase in back pressure can probably be attributed to the cross section of the channels on the input side not being significantly reduced due to the presence of coating F. It is assumed that coating F forms a porous structure, which has a positive effect on the back pressure. As a result of the coating F, a filter according to the invention additionally has a lower back pressure after soot loading than an analogous filter without coating F since this largely prevents soot from penetrating the porous filter wall.

Coating Z gives the wall flow filter according to the invention excellent three-way activity, while the optional coating Y is able to reduce the soot ignition temperature and thus facilitates soot burn-off.

The present invention thus also relates to the use of a wall flow filter according to the invention for reducing harmful exhaust gases of an internal combustion engine. The use of the wall flow filter according to the invention for treating exhaust gases of a stoichiometrically operated internal combustion engine, i.e. in particular a gasoline-operated internal combustion engine, is preferred.

The wall flow filter according to the invention is very advantageously used in combination with at least one three-way catalyst. In particular, it is advantageous if a three-way catalyst is located in a position close to the engine on the inflow side of the wall flow filter according to the invention. It is also advantageous if a three-way catalyst is located on the outflow side of the wall flow filter according to the invention. It is also advantageous if a three-way catalyst is located on the inflow side and on the outflow side of the wall flow filter. The preferred embodiments described for the wall flow filter according to the invention also apply mutatis mutandis to the use mentioned here.

The present invention further relates to an exhaust gas purification system comprising a filter according to the invention and at least one further catalyst. In one embodiment of this system, at least one further catalyst is arranged upstream of the filter according to the invention. Preferably, this is a three-way catalyst or an oxidation catalyst or a NOx storage catalyst. In a further embodiment of this system, at least one further catalyst is arranged downstream of the filter according to the invention. Preferably, this is a three-way catalyst or an SCR catalyst or a NOx storage catalyst or an ammonia slip catalyst. In a further embodiment of this system, at least one further catalyst is arranged upstream of the filter according to the invention and at least one further catalyst is arranged downstream of the filter according to the invention. Preferably, the upstream catalyst is a three-way catalyst or an oxidation catalyst or a NOx storage catalyst and the downstream catalyst is a three-way catalyst or an SCR catalyst or a NOx storage catalyst or an ammonia slip catalyst. The preferred embodiments described for the wall flow filter according to the invention also apply mutatis mutandis to the exhaust gas purification system mentioned here.

Typically, the filter according to the invention is used primarily in internal combustion engines, in particular in internal combustion engines with direct injection or intake manifold injection. These are preferably stoichiometrically operated gasoline or natural gas engines. Preferably, these are motors with turbocharging.

The requirements applicable to gasoline particulate filters (GPF) differ significantly from the requirements applicable to diesel particulate filters (DPF). Diesel engines without DPF can have up to ten times higher particle emissions, based on the particle mass, than gasoline engines without GPF (Maricq et al., SAE 1999-01-01530). In addition, there are significantly fewer primary particles in the case of gasoline engines, and the secondary particles (agglomerates) are significantly smaller than in diesel engines. Emissions from gasoline engines range from particle sizes of less than 200 nm (Hall et al., SAE 1999-01-3530) to 400 nm (Mathis et al., Atmospheric Environment 38 4347) with a maximum in the range of around 60 nm to 80 nm. For this reason, the nanoparticles in the case of GPF must mainly be filtered by diffusion separation. For particles smaller than 300 nm, separation by diffusion (Brownian molecular motion) and electrostatic forces becomes more and more important with decreasing size (Hinds, W: Aerosol technology: Properties and behavior and measurement of airborne particles. Wiley, 2nd edition 1999).

FIGS. 1 to 10 show the different coating arrangements of wall flow filters according to the invention, which are already described in more detail above. The following designations are used therein:
(E) the inlet channel/inflow channel of the wall flow filter
(A) the outlet channel/outflow channel of the wall flow filter
(O_{E}) the surfaces formed by the inlet channels (E)
(O_{A}) the surfaces formed by the outlet channels (A)
(L) the length of the filter wall
(Z) the coating Z
(Y) the coating Y
(F) the coating F

The advantages of the invention are explained using examples below.

### Comparative Example 1: Coating Z Only

Aluminum oxide stabilized with lanthanum oxide was suspended in water with a first oxygen storage component, which comprised 40% by weight cerium oxide, zirconium oxide, lanthanum oxide and praseodymium oxide, and a second oxygen storage component, which comprised 24% by weight cerium oxide, zirconium oxide, lanthanum oxide and yttrium oxide. Both oxygen storage components were used in equal parts. The weight ratio of aluminum oxide and oxygen storage component was 30:70. The suspension thus obtained was subsequently mixed with a palladium nitrate solution and a rhodium nitrate solution under constant stirring. The resulting coating suspension was used directly for coating a commercially available wall flow filter substrate, the coating being introduced into the porous filter wall over 100% of the substrate length. The total load of this filter amounted to 75 g/l; the total precious metal load amounted to 1.24 g/l with a ratio of palladium to rhodium of 6:1. The coated filter thus obtained was dried and then calcined. It is hereinafter referred to as VGPF1.

Example 1 according to the invention: Coating Z in combination with coating F:
Aluminum oxide stabilized with lanthanum oxide was suspended in water with a first oxygen storage component, which comprised 40% by weight cerium oxide, zirconium oxide, lanthanum oxide and praseodymium oxide, and a second oxygen storage component, which comprised 24% by weight cerium oxide, zirconium oxide, lanthanum oxide and yttrium oxide. Both oxygen storage components were used in equal parts. The weight ratio of aluminum oxide and oxygen storage component was 30:70. The suspension thus obtained was subsequently mixed with a palladium nitrate solution and a rhodium nitrate solution under constant stirring. The resulting coating suspension was used directly for coating a commercially available wall flow filter substrate, the coating being introduced into the porous filter wall over 100% of the substrate length. The total load of this filter amounted to 75 g/l; the total precious metal load amounted to 1.24 g/l with a ratio of palladium to rhodium of 6:1. The coated filter thus obtained was dried and then calcined. The filter was then coated on the surfaces O_{E} with a silicon carbide membrane. It is hereinafter referred to as GPF1.

The two filters thus obtained were subsequently measured on a cold-blast test bench in order to determine the pressure loss over the respective filter. At room temperature and a volumetric flow rate of 600 m³/h of air, the back pressure is 60 mbar for the VGPF1 and 74 mbar for the GPF1. As already described, the filtration coating F only leads to a moderate increase in back pressure.

At the same time, fresh VGPF1 and GPF1 filters were investigated in the vehicle in terms of their particle filtration efficiency. For this purpose, the filters were measured in a WLTP driving cycle in a position close to the engine between two particle counters. In both cases, a three-way catalyst was located upstream in the exhaust tract, through which the lambda control of the vehicle was effected. Here the filter GPF1 according to the invention has a filtration efficiency of 95%, calculated from the particle values of the two particle counters, while the comparative filter VGPF1 achieves a filtration efficiency of only 72%. Overall, it can be seen that the combination of filtration coating F and the three-way coating Z is particularly advantageous in terms of filtration efficiency. The combination option with the coatings Y and Z also allows a high conversion rate of the harmful exhaust gas components HC, CO and NON.

1. Wall flow filter for removing particles from the exhaust gas of combustion engines, comprising a wall flow filter substrate of length L and coatings Z and F that differ from one another,
wherein the wall flow filter substrate has channels E and A, which extend in parallel between a first and a second end of the wall flow filter substrate, are separated by porous walls and form surfaces O_{E} and O_{A} respectively, and wherein the channels E are closed at the second end and the channels A are closed at the first end, and
wherein the coating Z is located in the porous walls and/or on the surfaces O_{A}, but not on the surfaces O_{E}, and comprises palladium and/or rhodium and a cerium/zirconium mixed oxide,
characterized in that the coating F is located in the porous walls and/or
the surfaces O_{E}, but not on the surfaces O_{A}, and comprises a ceramic membrane, which is a coherent layer having a layer thickness of 1 to 150 μm, and no precious metal.

2. Wall flow filter according to claim 1, characterized in that coating Z is located on the surfaces O_{A} of the wall flow filter substrate and extends from the second end of the wall flow filter substrate to 50 to 90% of the length L.

3. Wall flow filter according to claim 1, characterized in that coating Z is located in the porous walls of the wall flow filter substrate and extends from the first end of the wall flow filter substrate to 50 to 100% of the length L.

4. Wall flow filter according to claim 1, characterized in that coating Z contains palladium and rhodium.

5. Wall flow filter according to claim 1, characterized in that coating Z does not contain platinum.

6. Wall flow filter according to claim 1, characterized in that the cerium/zirconium mixed oxide of the coating Z contains one or more rare earth metal oxides.

7. Wall flow filter according to claim 6, characterized in that the rare earth metal oxide is lanthanum oxide, yttrium oxide, praseodymium oxide, neodymium oxide and/or samarium oxide.

8. Wall flow filter according to claim 1, characterized in that coating Z comprises lanthanum-stabilized aluminum oxide, rhodium, palladium or palladium and rhodium, and a cerium/zirconium/rare earth metal mixed oxide containing yttrium oxide and lanthanum oxide as rare earth metal oxides.

9. Wall flow filter according to claim 1, characterized in that coating Z comprises lanthanum-stabilized aluminum oxide, rhodium, palladium or palladium and rhodium, and a cerium/zirconium/rare earth metal mixed oxide containing praseodymium oxide and lanthanum oxide as rare earth metal oxides.

10. Wall flow filter according to claim 1, characterized in that the ceramic membrane of the coating F contains one or more elements selected from the group consisting of silicon, aluminum, titanium, zirconium, cerium, iron, zinc, magnesium, tin and carbon.

11. Wall flow filter according to claim 1, characterized in that the ceramic membrane of the coating F contains aluminum oxide, zirconium dioxide, cerium oxide, zirconium oxide, yttrium oxide, mullite, tin oxide, silver nitride, zeolite, titanium dioxide, silicon dioxide, aluminum titanate, silicon carbide, cordierite, or mixtures thereof.

12. Wall flow filter according to claim 1, characterized in that the mass ratio of coating Z to coating F is 0.15 to 15.

13. Wall flow filter according to claim 1, characterized in that the ratio of the wall thickness of the wall flow filter substrate to the thickness of the coating F is 0.8 to 400.

14. Wall flow filter according to claim 1, characterized in that the wall flow filter substrate has a coating Y which is different from the coatings Z and F, which comprises platinum, palladium or platinum and palladium, which contains no rhodium and no cerium/zirconium mixed oxide and which is located in the porous walls and/or on the surfaces O_{E}, but not on the surfaces O_{A}.

15. Wall flow filter according to claim 14, characterized in that coating Y extends over a length of 50 to 100% of the length L.

16. Wall flow filter according to claim 1, characterized in that
the coating Z is located in the porous walls and/or on the surfaces O_{A}, but not on surfaces O_{E}, extends from the second end over 60 to 100% percent of the length L and comprises lanthanum-stabilized aluminum oxide, rhodium, palladium, or palladium and rhodium, as well as a cerium/zirconium/rare earth metal mixed oxide containing yttrium oxide or neodymium oxide or praseodymium oxide and lanthanum oxide as rare earth metal oxides, and
the coating F is located on the surfaces O_{E}, but not on the surfaces O_{A}, has a layer thickness of 1 to 150 μm and extends from the first end over a length of 80 to 100% of the length L.

17. Method for producing a wall flow filter according to claim 1, characterized in that the channels A of the dry wall flow filter substrate already coated with coating F are coated with the catalytically active coating Z and optionally coating Y.

18. A method for reducing harmful exhaust gases of an internal combustion engine, comprising passing the harmful exhaust gases of the internal combustion engine through a wall flow filter according to claim 1.
